(19) United States
(12) Patent Application Publication
(10) Pub. No.: US 2013/0112088 A1
(43) Pub. Date: May 9, 2013

(54) PARTITIONED GRILL AND ROTISSERIE

(71) Applicant: Randall L. May, Plano, TX (US)

(72) Inventor: Randall L. May, Plano, TX (US)

(21) Appl. No.: 13/461,590

(22) Filed: May 1, 2012

Related U.S. Application Data
(60) Provisional application No. 61/482,112, filed on May 3, 2011.

(51) Int. Cl. A47J 37/07

(52) U.S. Cl. CPC A47J 37/07
USPC 99/421 H

(57) ABSTRACT

The present invention is embodied in a grill having a firebox with a front rotisserie mount assembly and a pair of heat shield assemblies. The front rotisserie mount assembly is to help mount a rotisserie on the grill along a longitudinal axis extending from the front of the grill to the rear of the grill. The front rotisserie mount assembly also acts in conjunction with a pair of heat shield assemblies in the firebox to help concentrate heat generated underneath the rotisserie.

### CROSS-REFERENCE TO RELATED APPLICATIONS

This application claims priority from U.S. Provisional Patent Application No. 61/482,112, filed on May 3, 2011, the contents of which are incorporated herein by reference in their entirety.

### FIELD OF THE INVENTION

This invention pertains generally to the field of grilling appliances and, more particularly, to a grill having a firebox with a front rotisserie mount assembly and a pair of heat shield assemblies.

### BACKGROUND OF THE INVENTION

Outdoor grilling is a popular way to cook food. Most conventional outdoor grills typically include a firebox mounted on a cart. One or more burners are located inside the firebox and one or more cooking surfaces are positioned above the burners to provide a surface on which to cook the food. The burners are gas burners supplied with fuel for burning, commonly in the form of an attachment to an outlet to natural gas or to a portable fuel tank filled with liquid propane (LP) gas, which is supported on the cart. A warming rack is typically positioned on the firebox above and to the rear of the cooking surfaces. The firebox usually has a pivotably attached lid. Furthermore, outdoor grills often have one or more side shelves attached to the sides of the cart at a height approximate the cooking surface. The side shelves can provide additional work space and often support a side burner for cooking additional foods. A lid is usually pivotably attached to the side shelf having the side burner to protect the side burner when not in use.

Typically, the firebox of conventional outdoor grills is approximately rectangular in shape, having opposing front and rear walls and opposing side walls. The rear and side walls typically have upper walls as well. The burners are usually spaced horizontally apart from one another and are attached to the front and rear walls of the firebox, so that the burners extend rearwardly. Each burner is turned on or off and the heat setting is regulated by a corresponding knob located on a control panel of the cart.

In a conventional firebox, there is no means provided for confining or restricting the heat directly radiating from a burner to the food being cooked. This is especially disadvantageous when cooking a variety of foods on the grill simultaneously, such as steaks, hamburgers, poultry or vegetables, all of which may have widely differing cooking times and temperature requirements. Typically, the entire grill is preheated (by turning on multiple burners) before cooking, and even after preheating, more burners are used than necessary to cook the food because the heat in the firebox is not contained within a specific cooking area. This practice wastes fuel and does not provide even cooking, especially between burners that are operating at different heat settings.

Some prior grills have included a heat shield in order to compartmentalize the heat. For example, U.S. Pat. No. 6,065,464 shows a charcoal grill having a removable heat shield that divides the firebox into two smaller compartments to use fewer coals when heating less than the entire firebox. U.S. Pat. No. 5,163,358 shows a gas burner grill having a removable heat shield that divides the firebox into two smaller compartments to allow for differing heat levels in the compartments without transfer of heat from one compartment to another. Such heat shields are limited, however, because they only block transfer of the heat but do not help concentrate the intensity of the heat in a particular compartment, for example by reducing the area defined by the compartment so that the heat is dispersed upwardly through a narrower opening.

Many outdoor grills also include a rotisserie, commonly comprising a spit rod and pronged forks attached to an electric motor. In conventional grills, the rotisserie spans the width of the firebox, that is, the axis of the rotisserie extends from the left side wall of the firebox to the right side wall of the firebox. Typically the motor is mounted on an outer face of one of the upper side walls of the firebox. One end of the rotisserie is attached to the motor while the other end of the rotisserie is supported by a bracket or other attachment attached to the opposite upper side wall of the firebox. The axis of the rotisserie tends to require more than one burner, if not all the burners, to be turned on while the rotisserie is in use, so that food can be cooked if the food spans more than one burner.

The motor and, if applicable, the brackets of existing rotisseries tend to be attached only when they are being used and then removed because traditional rotisseries interfere with other uses of the outdoor grill. For example, in traditional rotisseries the motor and the spit rod protrude at least partially over the respective side tables, making it difficult to use the side tables or a side burner within a side table when the rotisserie is in use. The motor can be especially vulnerable to damage as it protrudes. This makes the rotisserie less convenient to use.

The upper side walls of the firebox and the opposing sides of the upper lid typically have corresponding cut-outs in order to allow the spit rod to pass through and be positioned across and above the firebox when the upper lid is closed. However, cut-outs tend to weaken the structural integrity of the firebox and of the upper lid. Heat can also escape from the cut-outs when the upper lid is closed. The aesthetic appearance of the upper side walls of the firebox and the opposing sides of the upper lid is diminished by the cut-outs as well

Accordingly, there is a need for a grill that does not suffer from the problems described above. More particularly, there is a need for a grill having a firebox that allows for more efficient dispersal of heat and for multi-zone heating to allow for better control of cooking food. There is also a need for a grill having a rotisserie that is easier to use, does not require as many burners to be in use and does not interfere with other uses of the grill if the rotisserie is being used. The present invention satisfies these and other needs, and provides further related advantages.

### SUMMARY OF THE INVENTION

The present invention resides in a grill having a firebox, a plurality of burners mounted in the firebox, a cooking surface positioned above the burners for grilling food, and rotisserie mounts for mounting a rotisserie spit above the cooking surface with its longitudinal axis extending in a front-to-rear direction for cooking food on the spit. One or more burners are positioned in the firebox beneath the rotisserie spit, and other burners are positioned in the firebox on one or both sides thereof. As a result, only the rotisserie burner or burners need to be operated when cooking food on the spit, but if desired, the grilling burner or burners can also be operated for cooking food on the grill at the same time.

In a further aspect of the invention, one or more heat shields are positioned in the firebox, extending front to rear, to divide the firebox into one or more compartments. The heat shields help contain and concentrate the heat from the burner(s) in each compartment to more efficiently cook food in that compartment. Also, the heat shields serve to substantially shield the burner(s) in each compartment from the burner(s) in other compartments, to allow food to be cooked at different temperature settings. For example, food on the rotisserie spit can be cooked at one temperature setting, while food on the cooking surfaces can be grilled at different temperature settings.

In a presently preferred embodiment, the firebox has opposing front and rear walls, a plurality of burners extending from proximate the front wall toward the rear of the firebox, a front rotisserie mount connected to the front wall, and a rear rotisserie mount connected to the rear wall, which may include an electric motor. The rotisserie spit may be removable to allow food to be cooked on a cooking surface above the rotisserie compartment. To this end, the front rotisserie mount may be configured to be pivoted from a grilling position in which the front rotisserie mount is flush with the cooking surface, to a rotisserie position in which the front rotisserie mount is upright and locked in position. The cooking surface may include an opening sized to accept the front rotisserie mount when the front rotisserie mount is in the grilling position.

In a further aspect of the invention, a pair of heat shields are positioned on opposite sides of the rotisserie burner(s). Each heat shield is pivotable between a grilling position in which it is upright and a rotisserie position in which it is inwardly angled toward the rotisserie spit to further concentrate the heat from the rotisserie burners on the food cooking on the spit. In the presently preferred embodiment, each heat shield comprises a heat shield assembly having a first or upper heat shield that is pivotable and a second or lower heat shield that is fixedly mounted in an upright position. Preferably, the combined height of the two heat shields in each heat shield assembly is substantially the same as the height of the fire box. The front rotisserie mount may be linked to the first heat shields with an operating mechanism that functions to simultaneously pivot both the front rotisserie mount and the first heat shields between the rotisserie position and the grilling positions. Preferably, in the rotisserie position, the operating mechanism locks the front rotisserie mount in its upright position.

In a further embodiment, a warming rack is placed on the firebox above the cooking surface and has a stationary member and a pivoting member. The pivoting member is configured to be pivoted from a grilling position, in which the pivoting member is substantially parallel to the cooking surface, to a rotisserie position, in which the pivoting member is substantially upright.

Other features and advantages of the invention will be apparent from the following detailed description of the preferred embodiments taken in conjunction with the accompanying drawings, which illustrate, by way of example, the principles of the invention.

### BRIEF DESCRIPTION OF THE DRAWINGS

Embodiments of the present invention will now be described, by way of example only, with reference to the following drawings.

FIG. 1 is a perspective view of a grill in accordance with the present invention.

FIG. 2 is a perspective view of an unassembled firebox for the grill of FIG. 1, without any components mounted therein.

FIG. 3 is a partial front perspective view of a partially assembled firebox shown mounted on the grill, with burner tubes installed and a warming rack, a front rotisserie mount, and first heat shields shown in the grilling position.

FIG. 4 is a partial rear perspective view of a partially assembled firebox similar to FIG. 3, showing the front rotisserie mount and the first heat shields in the rotisserie positions.

FIG. 5 is a top plan view of the grill of FIG. 1, showing the front rotisserie mount in the grilling position, flush with the cooking surface.

FIG. 6 is a partial right side perspective view of a partially assembled firebox with the left cooking surface in place, and the front rotisserie mount and the first heat shields in the grilling position.

FIG. 7 is a perspective view of a first heat shield showing a heat shield panel mounted on a heat shield pivot rod.

FIG. 8 is an exploded view of the front rotisserie mount assembly of the grill of FIG. 1, showing a pair of heat shield pivot rods with first heat shield panels removed for clarity.

FIG. 9 is a perspective view of the control shaft of the front rotisserie mount assembly of FIG. 8.

FIG. 10 is a front elevation view of the disc plate of the front rotisserie mount assembly of FIG. 8.

FIG. 11 is a front elevation view of the left linking member of the front rotisserie mount assembly of FIG. 8, the right linking member being a mirror image thereof.

FIG. 12 is a partial front perspective view of the grill of FIG. 1, with the cooking surfaces and the control panel removed, and the front rotisserie mount and the first heat shields in the grilling position.

FIG. 13 is a partial front perspective view of the grill of FIG. 1, with the cooking surfaces and the control panel removed, and the front rotisserie mount and the first heat shields partway between the grilling position and the rotisserie position.

FIG. 14 is a partial front perspective view of the grill of FIG. 1, with the cooking surfaces and the control panel removed, and the front rotisserie mount and the first heat shields in the rotisserie position.

FIG. 15 is a perspective view of the locking bracket of the front rotisserie mount assembly of FIG. 8.

FIG. 16 is a perspective view of the front rotisserie mount of the front rotisserie mount assembly of FIG. 8.

FIG. 17 is a perspective view of the left mounting bracket of the front rotisserie mount assembly of FIG. 8, the right mounting bracket being a mirror image thereof.

FIG. 18 is a partial left rear perspective view of the grill of FIG. 1, with the cooking surfaces removed and the front rotisserie mount and the primary heat shields in the grilling position.

FIG. 19 is a partial right rear perspective view of the grill of FIG. 1, with the cooking surfaces removed and the front rotisserie mount and the primary heat shields partway between the grilling position and the rotisserie position.

FIG. 20 is a partial left rear perspective view of the grill of FIG. 1, with the cooking surfaces removed and the front rotisserie mount and the primary heat shields in the rotisserie position.

FIG. 21 is a perspective view of the crank of the front rotisserie mount assembly of FIG. 8.

FIG. 22 is a front elevation view of the mounting link of the front rotisserie mount assembly of FIG. 8.

FIG. 23 is a partial front right perspective view of the grill of FIG. 1, with the control panel removed and the control shaft locked in the locking bracket in the grilling position.

FIG. 24 is a partial front left perspective view of the grill of FIG. 1, with the control panel removed and the control shaft locked in the locking bracket in the rotisserie position.

FIG. 25 is a perspective view of the rotisserie spit of the grill of FIG. 1.

FIG. 26 is a partial right rear perspective view of the grill of FIG. 1, with the motor shown detached from the motor mounting bracket.

FIG. 27 is a partial right rear perspective view of the grill of FIG. 1, with the motor mounted on the motor mounting bracket.

FIG. 28 is partial front right perspective view of the grill of FIG. 1, with the rotisserie mounted on the front rotisserie mount.

### DETAILED DESCRIPTION OF THE PREFERRED EMBODIMENTS

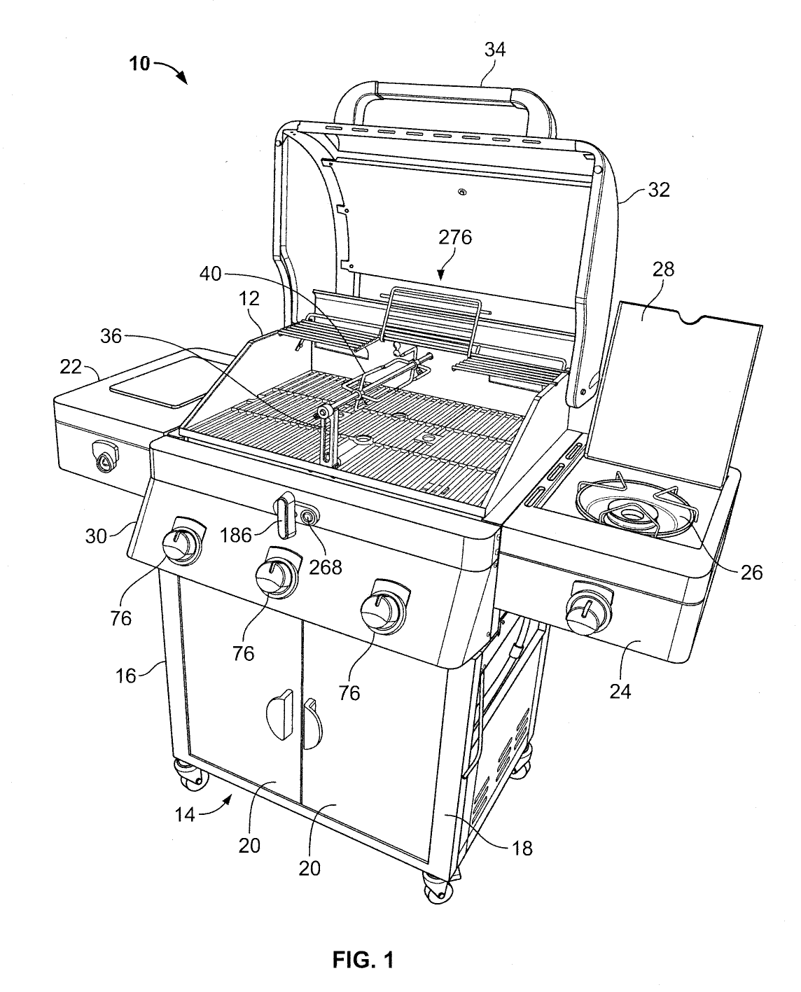

Referring now to the drawings, and particularly to FIG. 1 thereof, there is shown a grill 10 comprising a firebox 12 mounted on a cart assembly 14. The cart assembly 14 comprises a right side wall 16, a left side wall 18 and a pair of hinged front doors 20. The cart assembly 14 is adapted to house a fuel source, preferably an LP tank (not shown). A pair of side shelves 22 and 24 are attached to the right and the left side walls of the cart, respectively. The left side shelf is adapted to house a side burner 26 and has a pivotably attached lid 28. A control panel 30 is mounted to the front of the right and left side walls. A lid 32 is pivotably attached to the firebox and is pivotable between an open position and a closed position (not shown). A handle 34 is attached to the lid.

With continued reference to FIG. 1, the firebox 12 includes a front rotisserie mount 36, which is one component of a front rotisserie mount assembly 38. One feature of the front rotisserie mount assembly 38 is to help mount a rotisserie 40 on the grill 10 along a longitudinal axis extending from the front of the grill to the rear of the grill. Another feature of the front rotisserie mount assembly 38 is to act in conjunction with a pair of heat shield assemblies 42 in the firebox 12 to help concentrate heat generated underneath the rotisserie 40. These features of the front rotisserie mount assembly 38 will be discussed in further detail below.

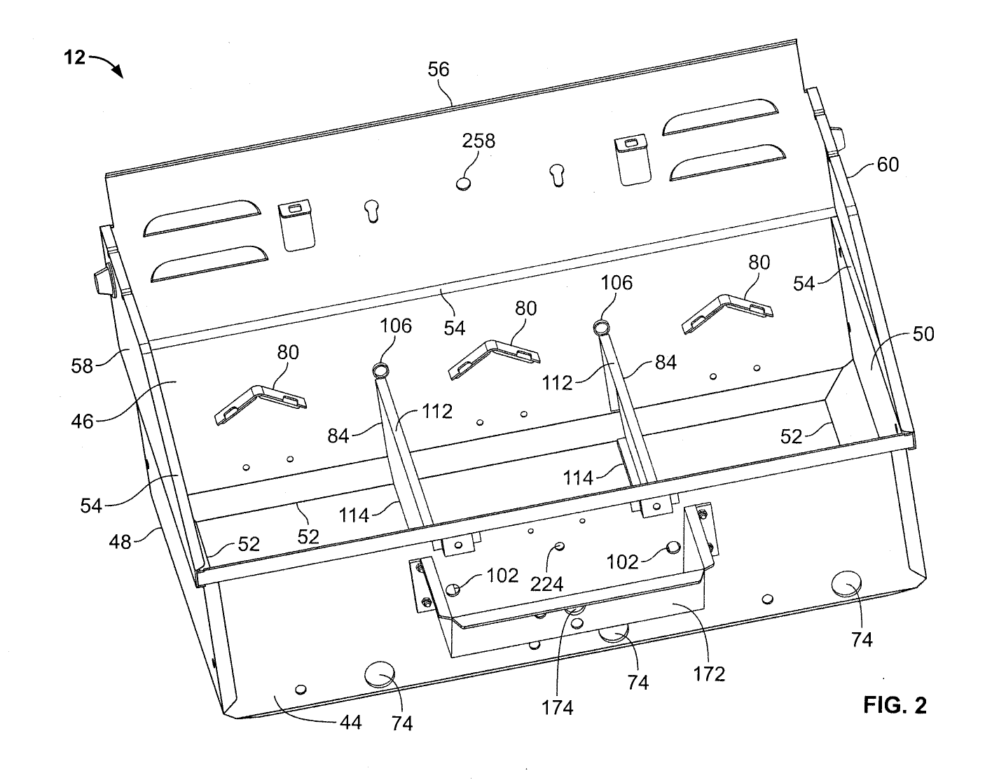

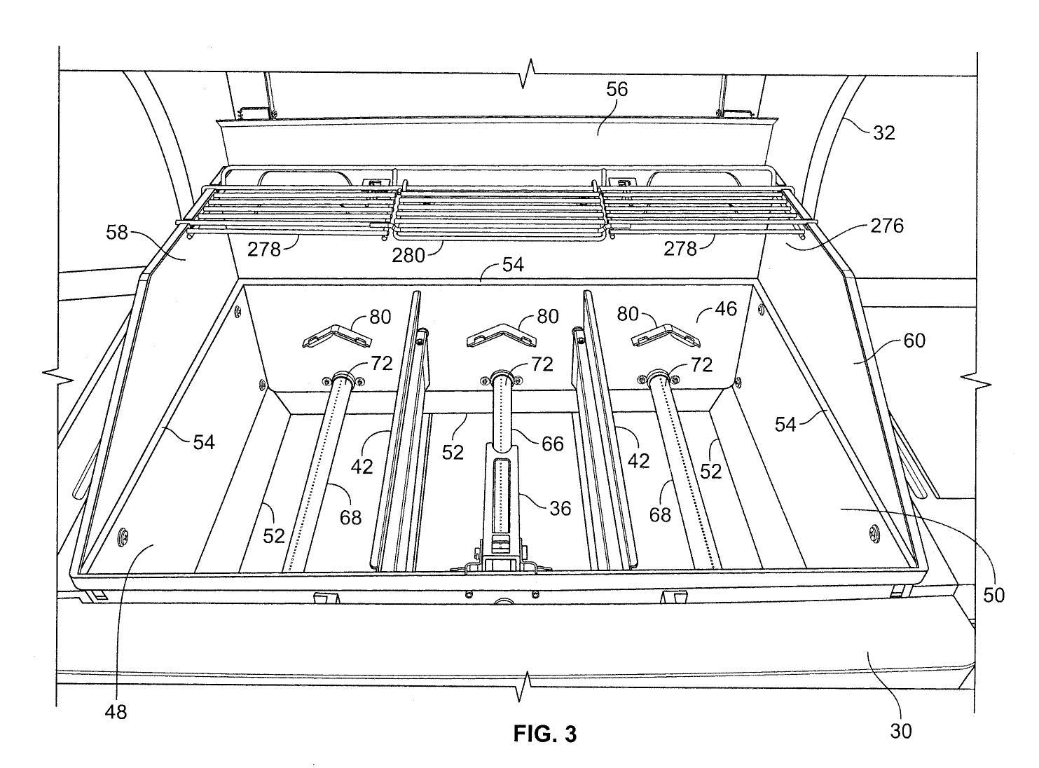

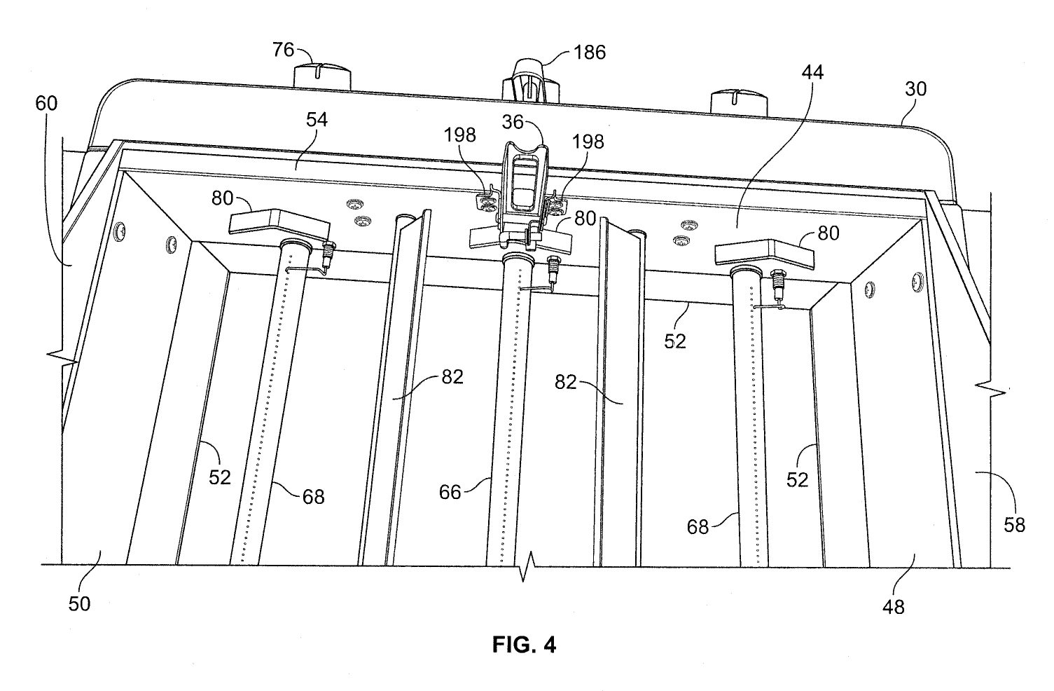

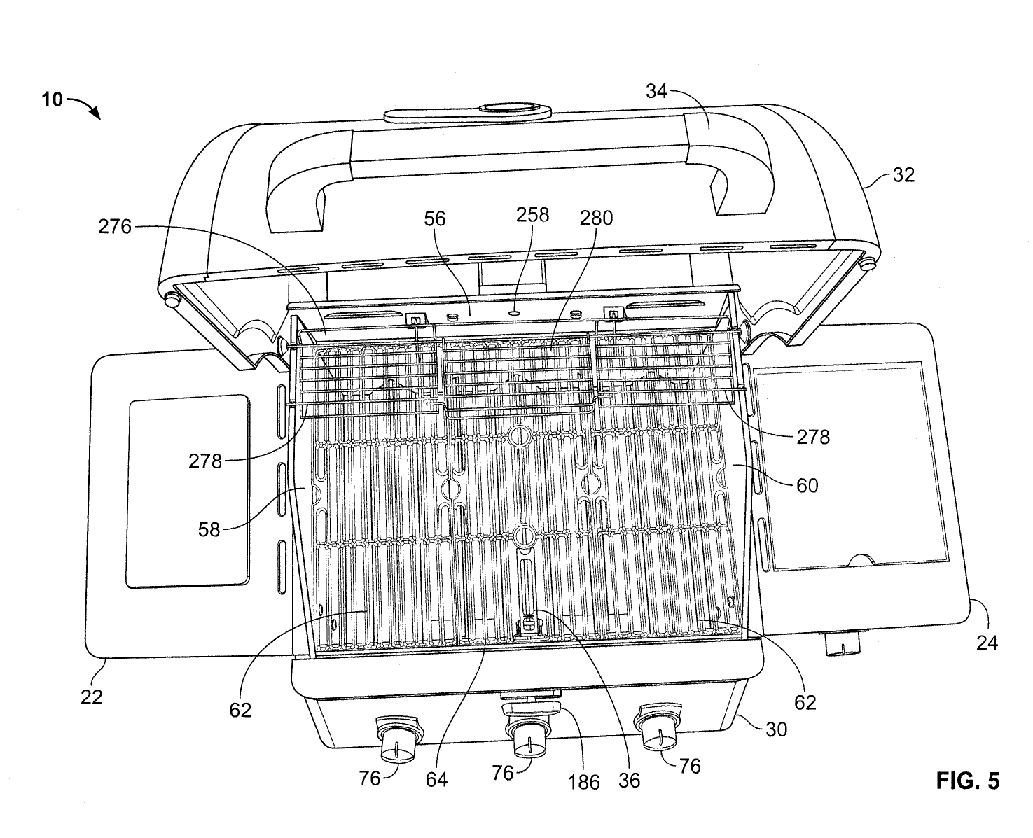

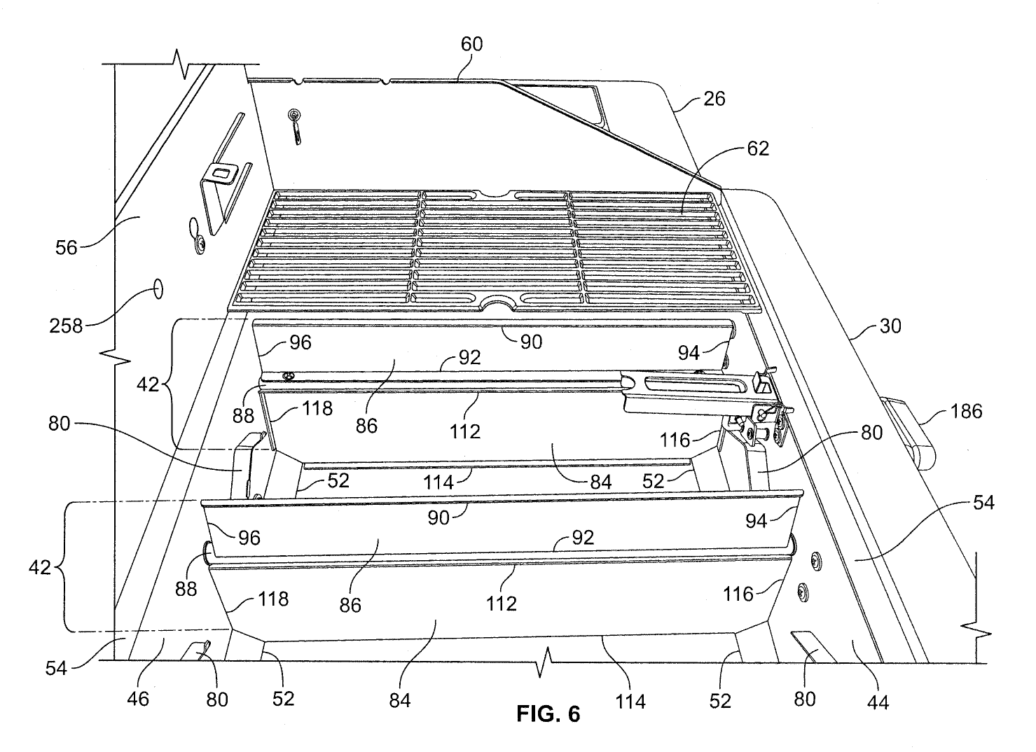

As shown in FIG. 2, the firebox 12 is substantially a rectangular shape defined by a front wall 44, a rear wall 46, a right side wall 48 and a left side wall 50, wherein each wall has a bottom edge 52. Each of the walls 44, 46, 48 and 50 also has an upper edge forming a lip 54 (FIGS. 3-4). The rear, right and left walls continue upwardly to create an upper rear wall 56, an upper right side wall 58 and an upper left side wall 60. As shown in FIG. 5, the lip 54 of the firebox 12 supports two side cooking surfaces 62 and a middle cooking surface 64. In a preferred embodiment the cooking surfaces are grates. The grates are positioned adjacent to one another with the middle cooking surface 64 positioned between the two side cooking surfaces 62. The cooking surfaces 62 and 64 are substantially identical in shape and size, in the form best seen in FIG. 6. The upper surfaces of the grates define a cooking surface for food.

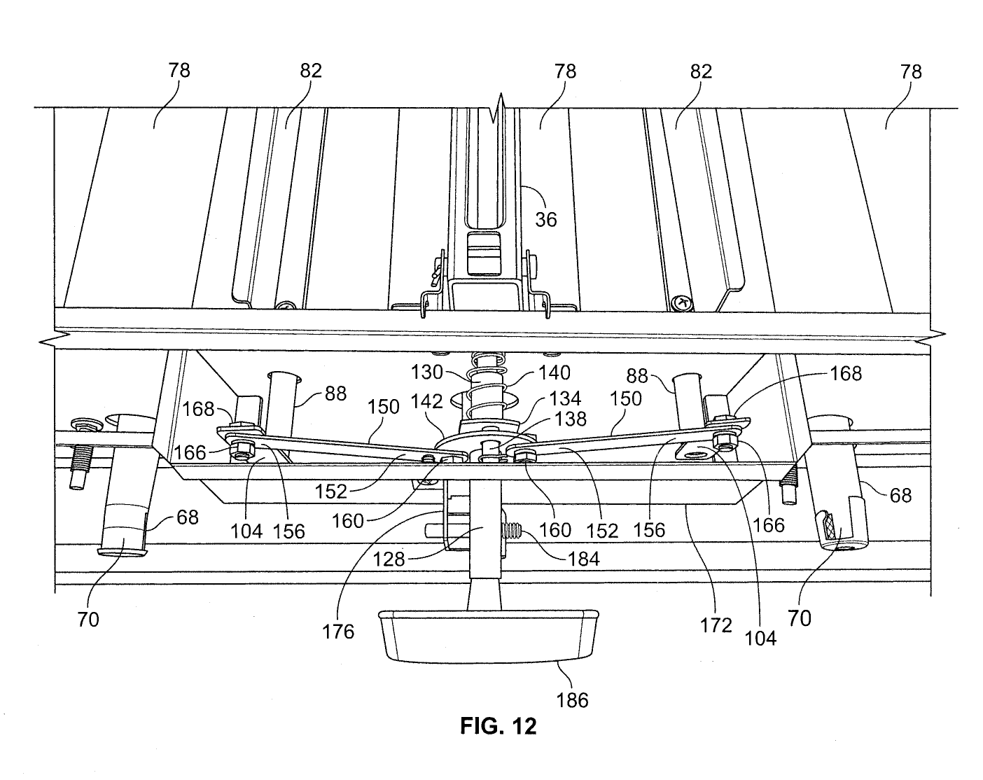

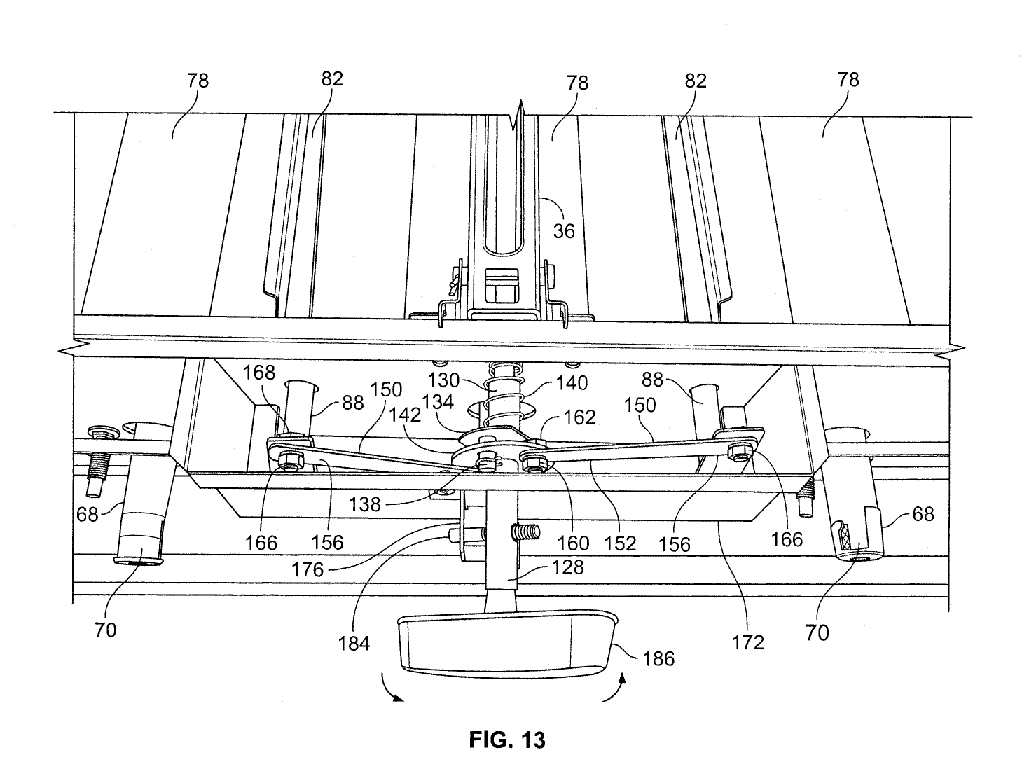

Referring to FIGS. 3, 4, 23 and 24, the firebox also houses a middle burner tube 66 and two side burner tubes 68. Each burner tube defines a longitudinal axis and has a front end 70 and a rear end 72. Each rear end 72 is fixedly attached to the rear wall 46 of the firebox. Each front end 70 extends through holes 74 in the front wall 44 of the firebox and is attached to a burner ignition assembly (not shown) mounted on the control panel 30. Thus, it will be appreciated that the longitudinal axes of the burner tubes extend from the front wall 44 to the rear wall 46 of the firebox 12. The heat emitted from each burner tube 66 and 68 is controlled independently by a corresponding burner control knob 76 on the control panel 30. The burner tubes are spaced horizontally apart, with the middle burner tube 66 positioned between the side burner tubes 68 and approximately equidistant between the right side wall 48 and the left side wall 50 of the firebox 12. As best seen in FIGS. 12-14 and 18-20, a heat plate 78 is positioned above each burner tube 66 and 68 to prevent food particles from falling through the grates 62 and 64 and making contact with the burner tubes. As shown in FIGS. 5-6, each heat plate 78 rests atop a pair of heat plate brackets 80 mounted on the front wall 44 and rear wall 46 of the firebox 12.

As shown in FIG. 6, in one embodiment of the present invention, the grill 10 includes the pair of heat shield assemblies 42 disposed within the firebox 12 to partition the heat emanating from the burner tubes and also to concentrate the heat emanating from the middle burner tube 66. The pair of heat shield assemblies 42 define longitudinal axes substantially parallel to the longitudinal axes defined by the burner tubes 66 and 68. Each heat shield assembly 42 comprises a first heat shield 82 and a second heat shield 84.

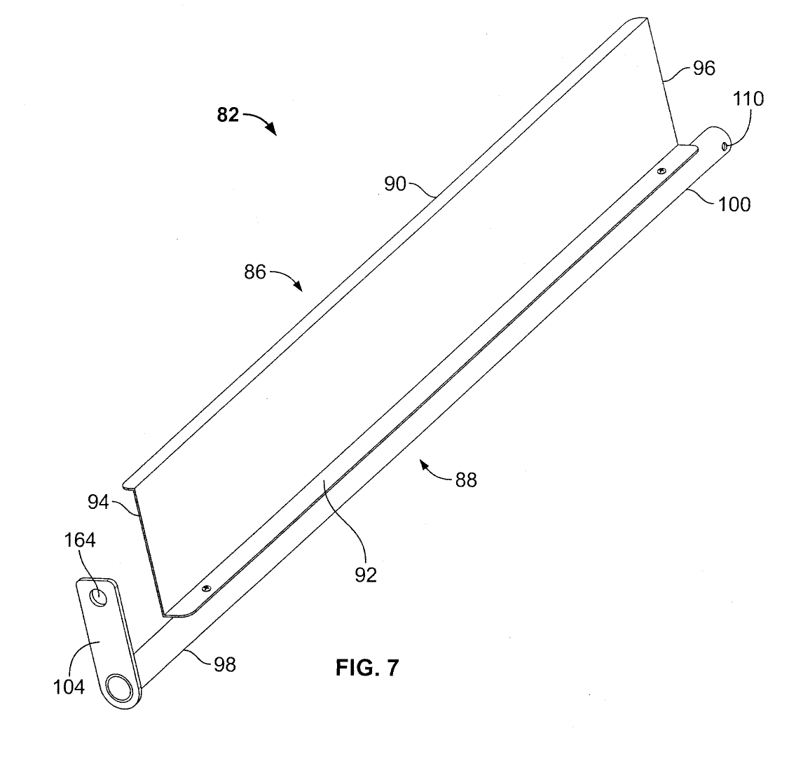

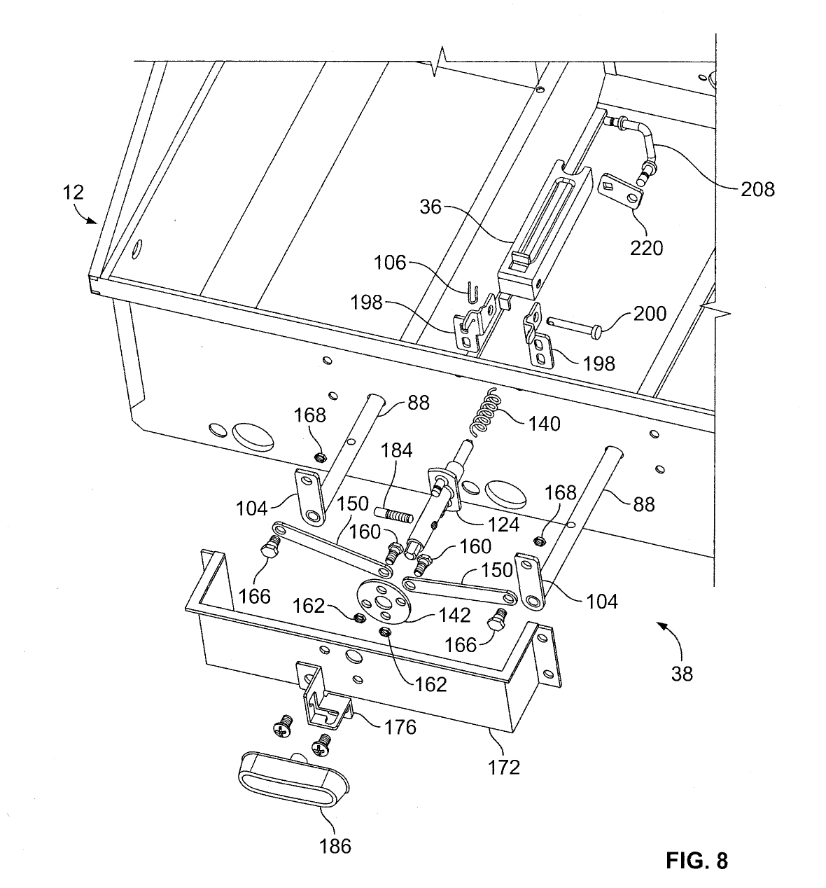

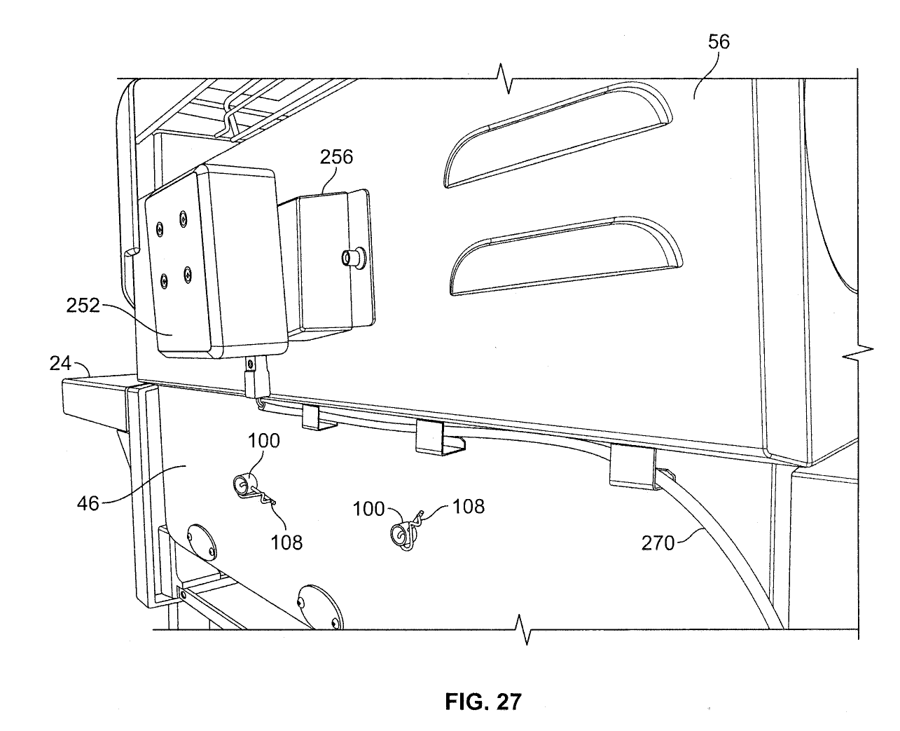

As shown in FIG. 7, the first heat shield 82 includes a first panel 86 and a rod 88. The first panel 86 is substantially rectangular in shape, having a top edge 90, a bottom edge 92, a front edge 94 and a rear edge 96. The first panel 86 is fixedly attached to the rod 88 along the bottom edge 92. The rod 88 has a front end 98 and a rear end 100. As shown in FIG. 8, each front end 98 extends through a rod hole 102 formed in the front wall 44 of the firebox 12. A flange 104 is fixedly attached to the front end 98. As shown in FIGS. 2, 6 and 27, each rear end 100 extends through a rod hole 106 formed in the rear wall 46 of the firebox 12. A pin 108 (FIG. 27) extends through a transverse hole 110 on the rear end 100 of the rod 88 in order to prevent the rear end 100 from slipping through the rod hole 106 into the firebox 12.

The second heat shield 84 is a panel, substantially rectangular in shape, having a top edge 112, a bottom edge 114, a front edge 116 and a rear edge 118. The front edge 116 and the rear edge 118 are fixedly attached, preferably welded, to the front wall 44 and the rear wall 46, respectively. The bottom edge 114 of the second heat shield 84 is substantially coterminus with the bottom edges 52 of the front wall 44 and the rear wall 46 of the firebox 12.

As shown in FIGS. 3 and 6, each first heat shield 82 is positioned in the firebox 12 so that it is directly above and vertically aligned with its corresponding second heat shield 84. The major surfaces of the first heat shield 82 and the second heat shield 84 form planes, wherein the planes of the first heat shields and the second heat shields are parallel. The top edge 90 of each first heat shield 82 sits below the lip 54 of the firebox 12. The front edge 94 and the rear edge 96 of the first panel 86 are adjacent to but are not attached to the front wall 44 and the rear wall 46, respectively, of the firebox 12. In a preferred embodiment, the front edge 94 and the rear edge 96 do not contact the front wall 44 and the rear wall 46.

The pair of heat shield assemblies 42 are positioned on either side of the middle burner tube 66. Thus, it will be appreciated that the pair of heat shield assemblies 42 define two outer compartments 120 and a middle compartment 122 inside the firebox 12, wherein each outer compartment 120 contains one of the side burner tubes 68 and the middle compartment 122 contains the middle burner tube 66. Thus the pair of heat shield assemblies 42 assist in partitioning the heat from each burner tube within its corresponding compartment. It will be further appreciated that the heat generated by each burner tube in the outer compartments 120 and the middle compartment 122 can be independently varied and adjusted so that foods requiring different heat levels or cooking times can be cooked simultaneously on the grill 10 with more efficient compartmentalization of the heat.

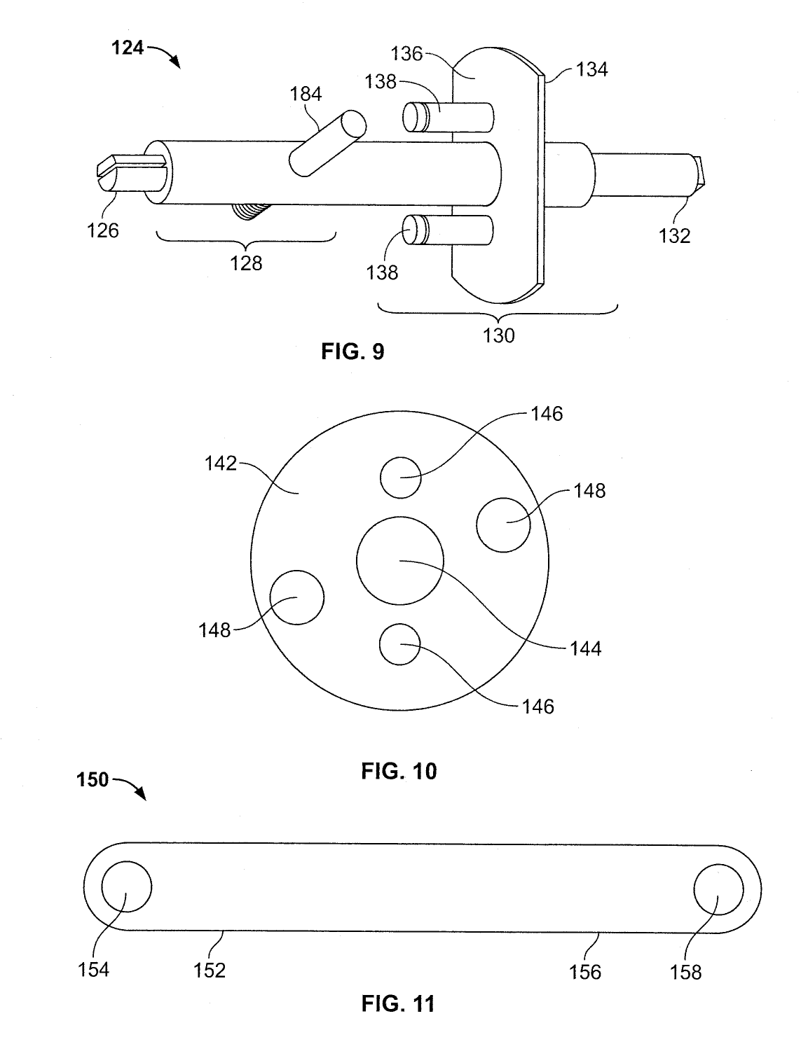

In another embodiment of the present invention, the grill 10 includes the front rotisserie mount assembly 38 for mounting the rotisserie 40. FIG. 8 shows an exploded view of the front rotisserie mount assembly 38. Referring to FIG. 9, the front rotisserie mount assembly 38 includes a control shaft 124, defining a longitudinal axis, wherein the control shaft 124 has a knob end 126, a first body section 128, a second body section 130 and a bracket end 132. The first body section 128 of the control shaft 124 is adjacent to the knob end 126. The second body section 130 is adjacent to the bracket end 132.

With continued reference to FIG. 9, a transverse plate 134, having a front face 136, is fixedly attached to the second body section 130 of the control shaft 124. A pair of fingers 138 project outwardly from the front face 136 in a spaced apart and diametrically opposed orientation to the control shaft 124 and along axes substantially parallel to the longitudinal axis defined by the control shaft 124. As shown in FIGS. 12-14, a coiled spring 140 is disposed generally around the second body section 130, behind the transverse plate 134.

As shown in FIG. 10, the front rotisserie mount assembly 38 further includes a disc plate 142 having a center hole 144, a first pair of disc plate holes 146 and a second pair of disc plate holes 148. Referring to FIGS. 8 and 12-14, the disc plate 142 is positioned on the second body section 130 of the control shaft 124 such that it is received through the center hole 144 and the pair of fingers 138 on the transverse plate 134 are received through the first pair of disc plate holes 146.

As shown in FIG. 11, the front rotisserie mount assembly 38 further includes a pair of linking members 150, each having an inner end 152 defining a hole 154 and an outer end 156 defining a hole 158. As shown in FIGS. 8 and 12-14, each hole 154 on the inner end 152 is aligned with one of the second pair of disc plate holes 148 on the disc plate 142. A fastener 160 is inserted through the aligned holes 154 and 148 and secured with a bolt 162, so that each linking member 150 is pivotably attached to the disc plate 142. Each hole 158 on the outer end 156 of the linking member 150 is aligned with a hole 164 defined in each flange 104 of the primary heat shield rod 88. A fastener 166 is inserted through the aligned holes 158 and 164 and secured with a bolt 168, so that each linking member 150 is also pivotably attached to each first heat shield 82.

Referring to FIGS. 12-14, the second body section of the control shaft 124, the disc plate 142, the pair of linking members 150, the pair of flanges 104 of the primary heat shield rods 88 and the coiled spring 140 are all housed within a recess 170 created by a U-shaped bracket 172 that is fixedly attached to the outer face of the front wall 44 of the firebox 12.

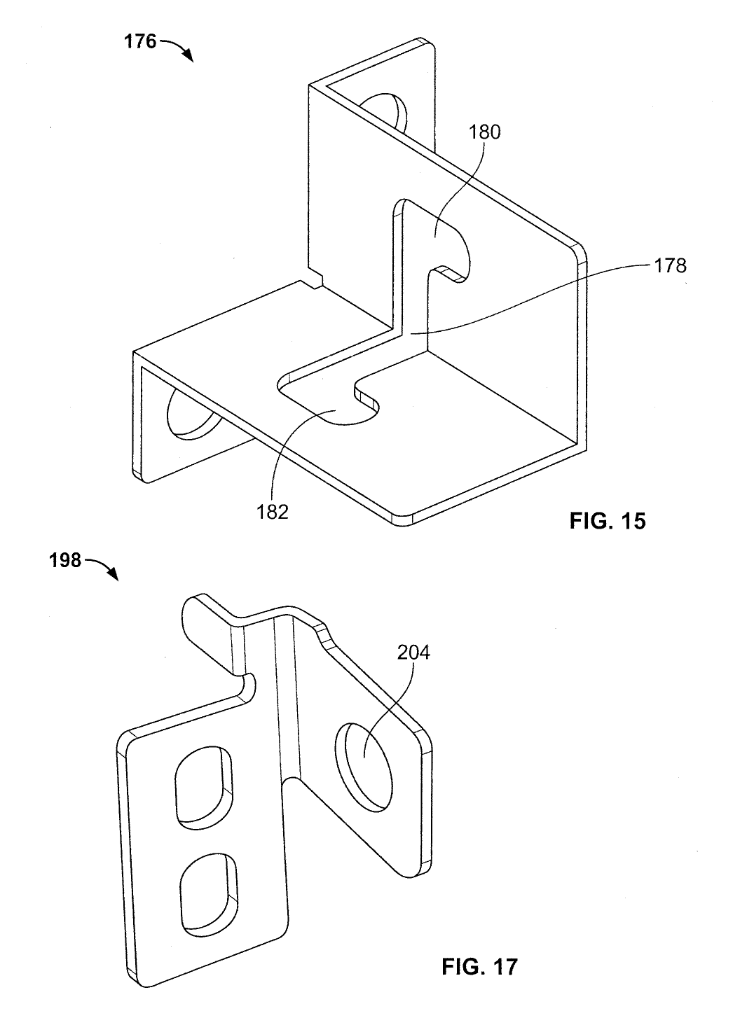

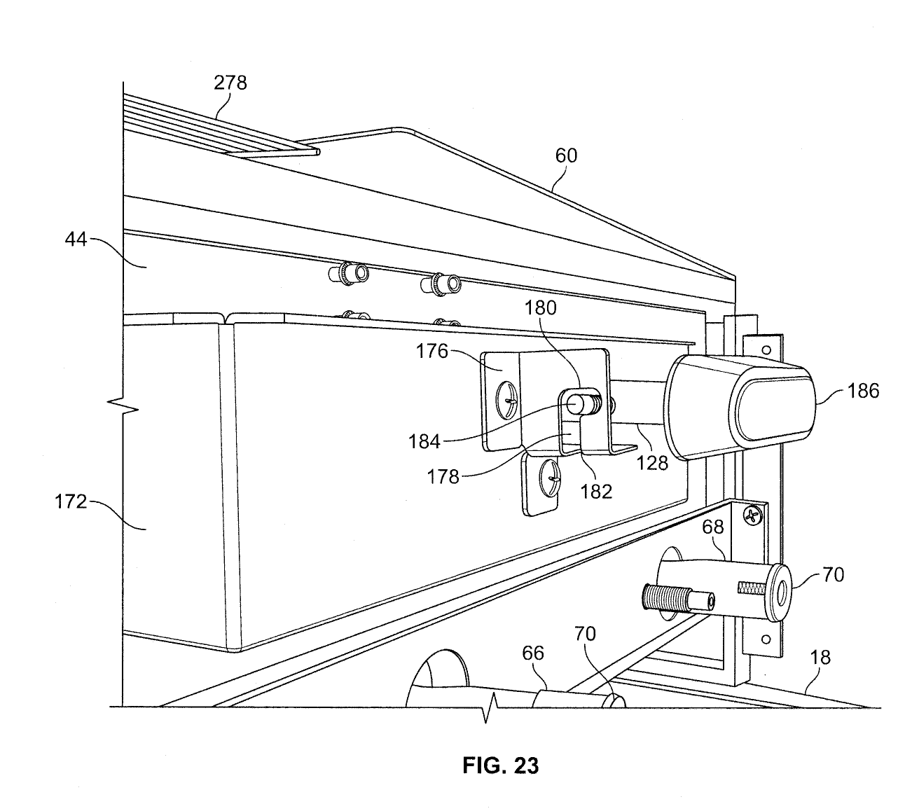

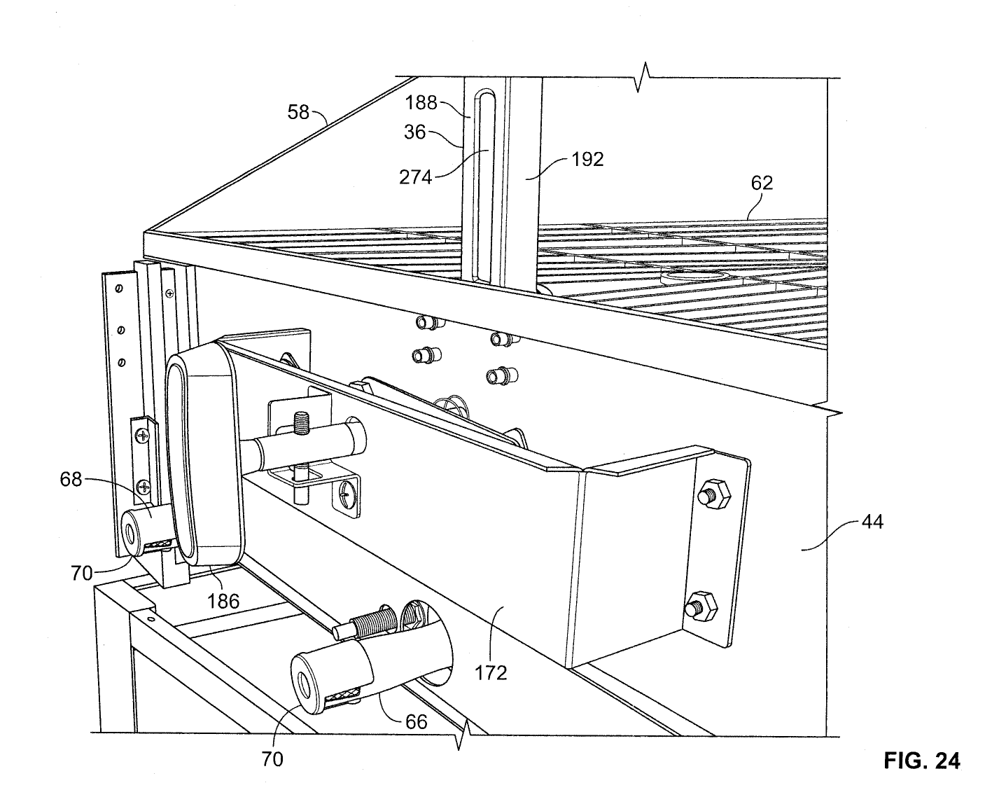

As shown in FIGS. 8 and 12-14, the control shaft 124 extends through a support hole 174 defined in the U-shaped bracket 172 on the firebox 12, such that the first body section 128 is housed substantially outside the recess 170 of the U-shaped bracket 172 but behind the control panel 30. A locking bracket 176 (FIG. 15) is fixedly attached to the outer face of the U-shaped bracket 172 near the support hole 174. The locking bracket 176 has a vertical slot 178 that extends into an upper horizontal slot 180 and a lower horizontal slot 182. As shown in FIGS. 23-24, a shaft bar 184 on the first body section 128 of the control shaft 124 is engaged with the vertical slot 178 and is movable between the upper horizontal slot 180 and the lower horizontal slot 182, as will be described in further detail below. The knob end 126 of the control shaft 124 extends through a hole (not shown) in the control panel 30. A knob 186 is attached to the knob end 126.

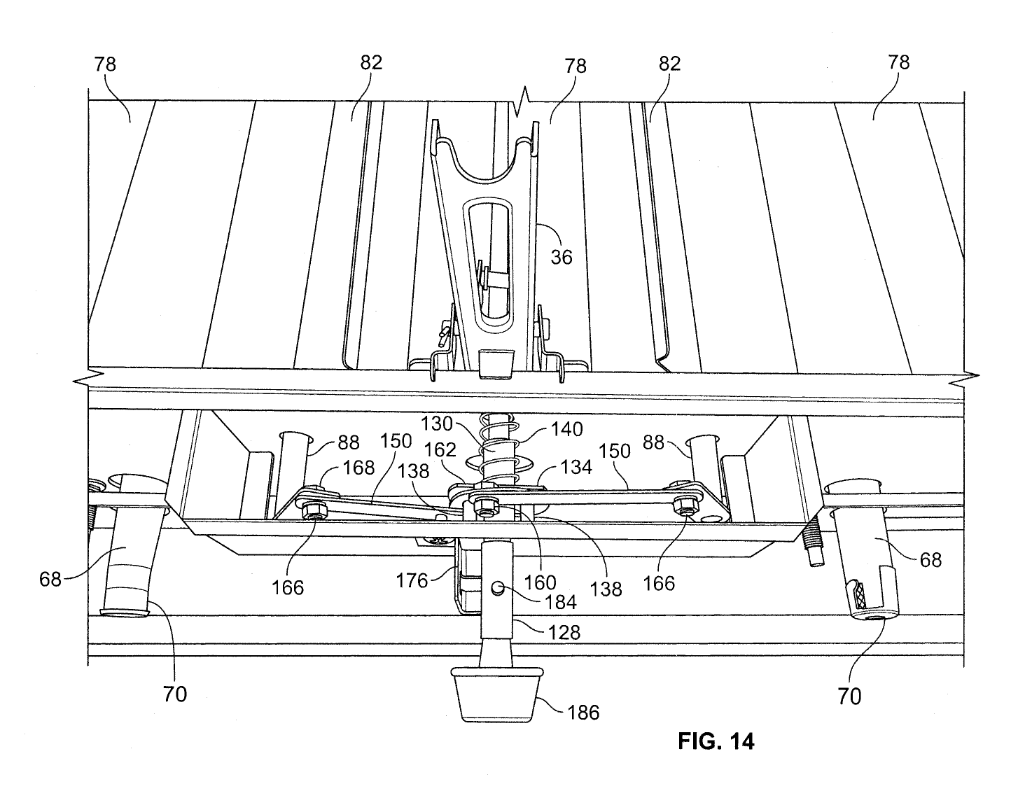

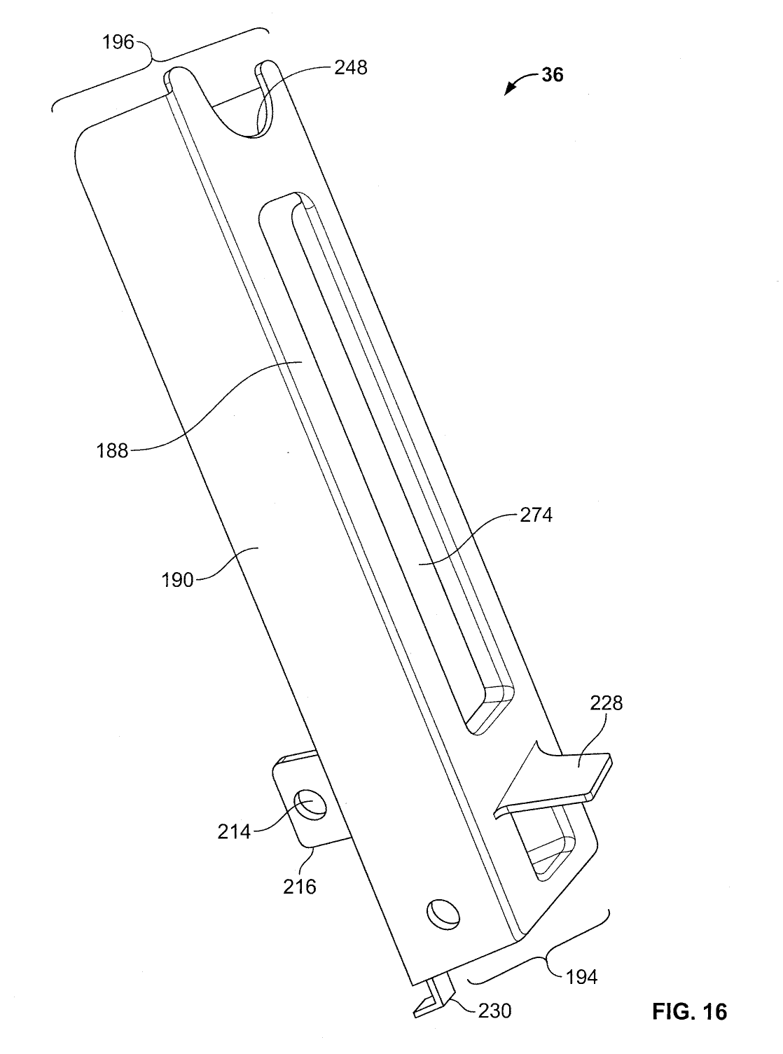

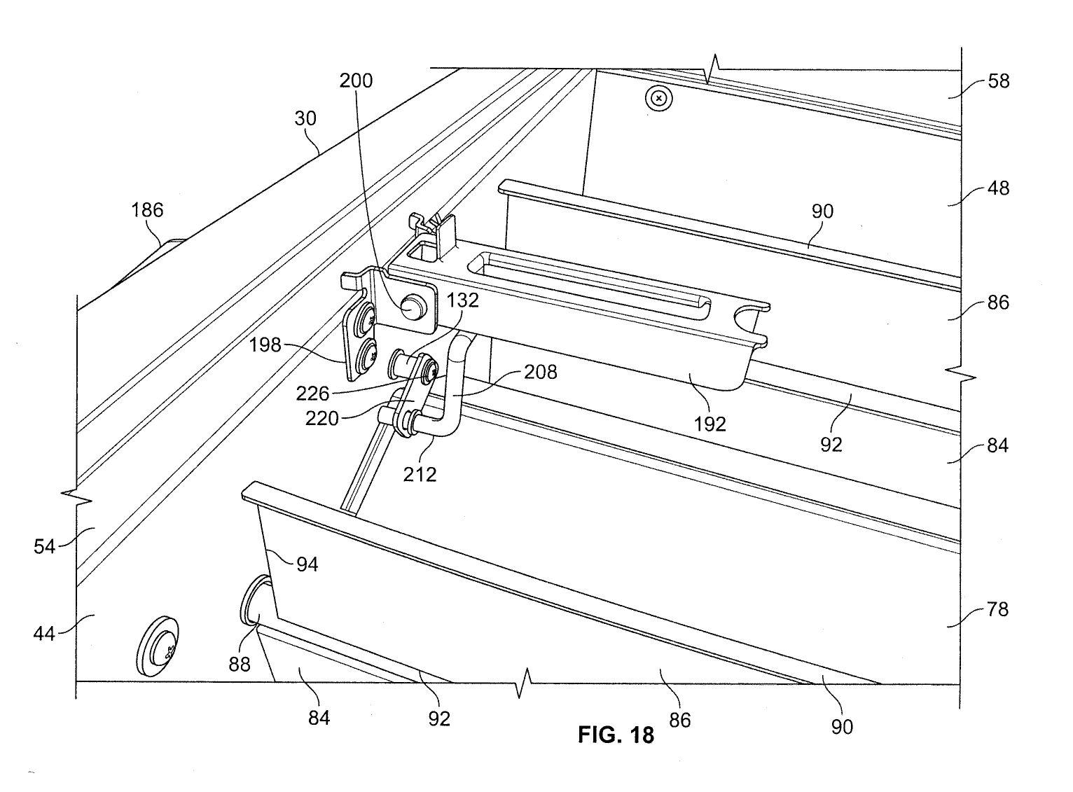

The front rotisserie mount assembly 38 further includes the front rotisserie mount 36. As shown in FIG. 16, the front rotisserie mount 36 has a center bar 188, a right bar 190 and a left bar 192 (FIG. 18), each having a base end 194 and a remote end 196. The front rotisserie mount 36 has substantially a U-shaped cross-sectional configuration along its entire length (FIG. 14). As shown in FIGS. 18-20, the front rotisserie mount 36 is flanked by a pair of mounting brackets 198 (FIG. 17) that are fixedly attached to the inner side of the front wall 44 of the firebox 12. A bracket rod 200 passes through holes 202 defined on the right bar 190 and the left bar 192 of the front rotisserie mount 36 near their base end 194, and a corresponding hole 204 on each mounting bracket 198, pivotably attaching the front rotisserie mount 36 to the pair of mounting brackets 198. The bracket rod 200 is secured in place by a pin 106.

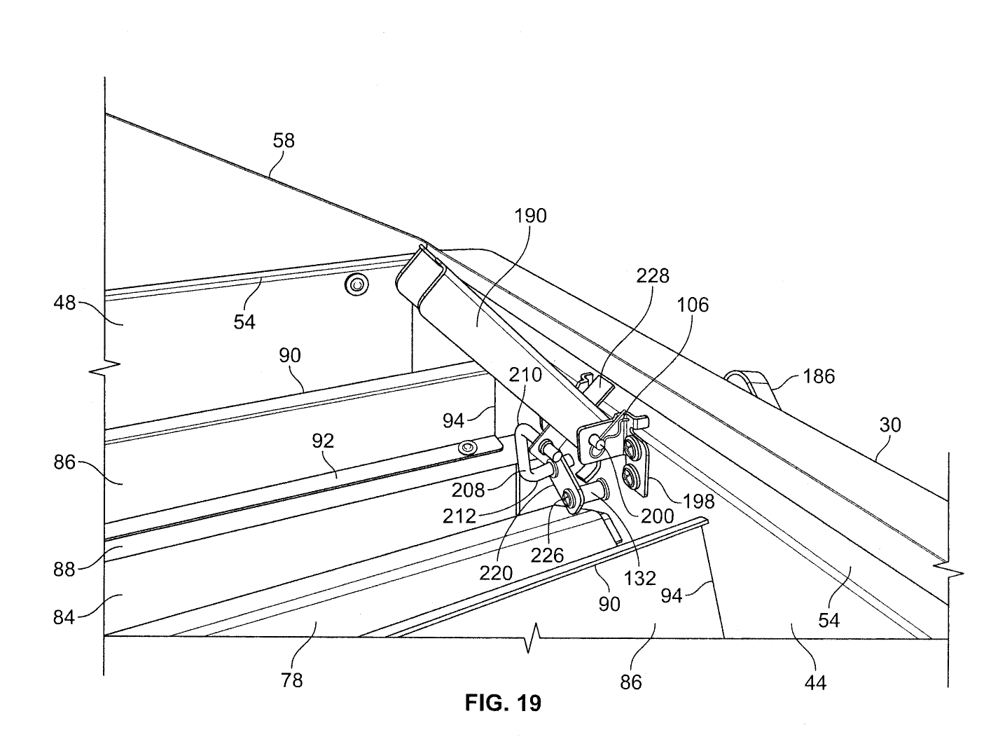

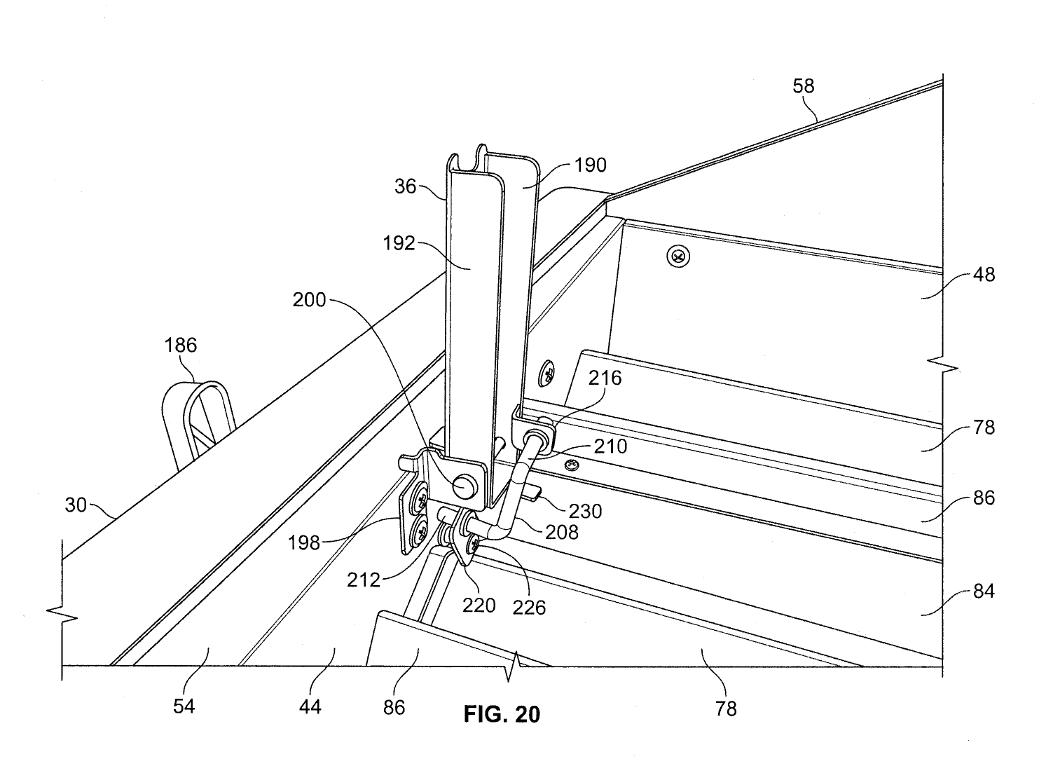

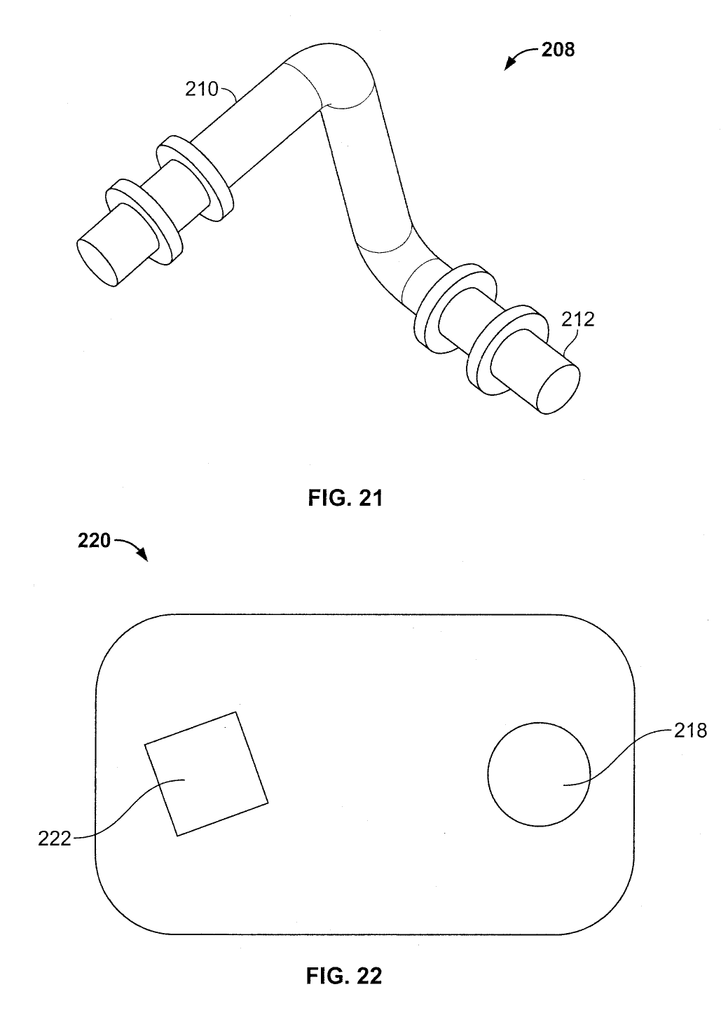

The front rotisserie mount assembly 38 further includes a crank 208 (FIG. 21) having an upper arm 210 and a lower arm 212. As shown in FIGS. 19 and 20, the upper arm 210 of the crank 208 extends through a hole 214 on a side tab 216 located near the base end 194 of the right bar 190 of the front rotisserie mount 36. The lower arm 212 of the crank 208 extends through a first hole 218 defined in a mounting link 220 (FIG. 22). Both the upper arm 210 and the lower arm 212 are pivotable within their respective holes 214 and 218. As shown in FIGS. 18-20, a second hole 222 defined in the mounting link 220 is adapted to receive the bracket end 132 of the control shaft 124, which extends rearwardly into the middle compartment 122 of the firebox 12 through a front rotisserie hole 224 (FIG. 2) on the front wall 44 of the firebox 12. The bracket end 132 of the control shaft 124 is fixedly attached to the mounting link 220 with a fastener 226. The front rotisserie hole 224 is approximately equidistant between the right side wall 48 and the left side wall 50 of the firebox 12 and aligned with the support hole 174 on the U-shaped bracket 172.

As best shown in FIGS. 12-14, the front rotisserie mount 36 is pivotable between a first resting position, in which the front rotisserie mount is horizontal and lies flush with the cooking surface, and a second rotisserie position, in which it is upright and perpendicular to the cooking surface in order to enable the rotisserie 40 to be deployed. To pivot the front rotisserie mount 36 from the first position to the second rotisserie position, the knob 186 is rotated counterclockwise, causing a counterclockwise rotation of the control shaft 124. This causes the counterclockwise rotation of the mounting link 220. As shown in FIGS. 18-20, the rotation of the mounting link 220 exerts an upward force on the crank 208, resulting in the upward motion of the crank 208 which, in turn, applies an upward force to the side tab 216 on the front rotisserie mount, causing the front rotisserie mount 36 to pivot upwardly about the bracket rod 200 to a vertical position. A center tab 228 (FIG. 16) projecting outwardly from the base end 194 of the center bar 188 of the front rotisserie mount 36 prevents the front rotisserie mount 36 from over pivoting beyond its upright grilling position by making contact with the lip 54 on the firebox 12 and acting as a stop (FIG. 14).

In another embodiment of the present invention, the same counterclockwise rotation of the knob 186 results in rotation of the first heat shields 82 from a first vertical position to a second inwardly pivoted position. The counterclockwise rotation of the knob 186 causes the counterclockwise rotation of the control shaft 124, the transverse plate 134 and the disc plate 142. This counterclockwise rotation of the disc plate 142 results in force being applied to the pivotably attached linking members 150, such that the linking members 150 are pulled inwardly in a counterclockwise direction. The resulting movement of the linking members 150 causes the primary heat shield rod flanges 104 pivotably attached to the linking members 150 to be pulled inwardly too. Thus, the first heat shield 82 near the left side wall 50 of the firebox 12 pivots inwardly counterclockwise and the first heat shield 82 near the right side wall 48 of the firebox 12 turns inwardly clockwise, thereby narrowing the middle compartment 122 containing the middle burner tube 66 (FIGS. 3-4). It will thus be appreciated that rotation of the first heat shields 82 results in concentration of heat in the middle compartment 122, because heat emanating from the middle burner tube 66 has less area to travel through as it emanates upwardly. In a preferred embodiment, the degree of rotation of the first heat shields is less than 90° and preferably 45° or less.

Accordingly, the single force applied to the front rotisserie mount assembly 38 results in a concerted action that simultaneously pivots the front rotisserie mount 36 from a horizontal position to a vertical position and pivots the first heat shields inwardly toward each other.

In a further embodiment, accidental rotation of the knob 186 is prevented by the shaft bar 184. The shaft bar 184 extends transversely through a hole in the first body section 128. As shown in FIG. 23, when the front rotisserie mount assembly 38 is in the first position, the shaft bar 184 is positioned within the upper horizontal slot 180 of the locking bracket 176. Movement into the second position is prevented unless a force is applied to the knob 186 sufficient to overcome the opposing force created by the coiled spring 140 so that the control shaft 124 is pushed inwardly toward the firebox 12. The inward movement of the control shaft 124 parallel to the axis defined by the control shaft 124 causes the shaft bar 184 to exit the upper horizontal slot 180 in the locking bracket 176. Thereafter, a user is free to rotate the knob 186 in the counterclockwise direction, causing the shaft bar 184 to move downwardly in the vertical slot 178. As inward force is removed from the knob 186 following counterclockwise rotation, the outward force exerted by compression of the coiled spring 140 causes the shaft bar 184 to enter the lower horizontal slot 182, as shown in FIG. 24.

It should be appreciated that the opposite process is followed to pivot the front rotisserie mount 36 to its first grilling position and the first heat shields 82 to their first vertical position. A base tab 230 (FIG. 16) projecting outwardly from the base end 194 of the center bar 188 of the front rotisserie mount 36 prevents the front rotisserie mount 36 from pivoting lower beyond its flush grilling position by making contact with the front wall 44 of the firebox 12 and acting as a stop (FIG. 19). It should be further appreciated that the rotation in a counterclockwise direction to move the front rotisserie mount 36 into the second position is a preferred embodiment only, and that the front rotisserie mount assembly 38 could be easily configured for clockwise rotation, with all subsequent actions revised accordingly.

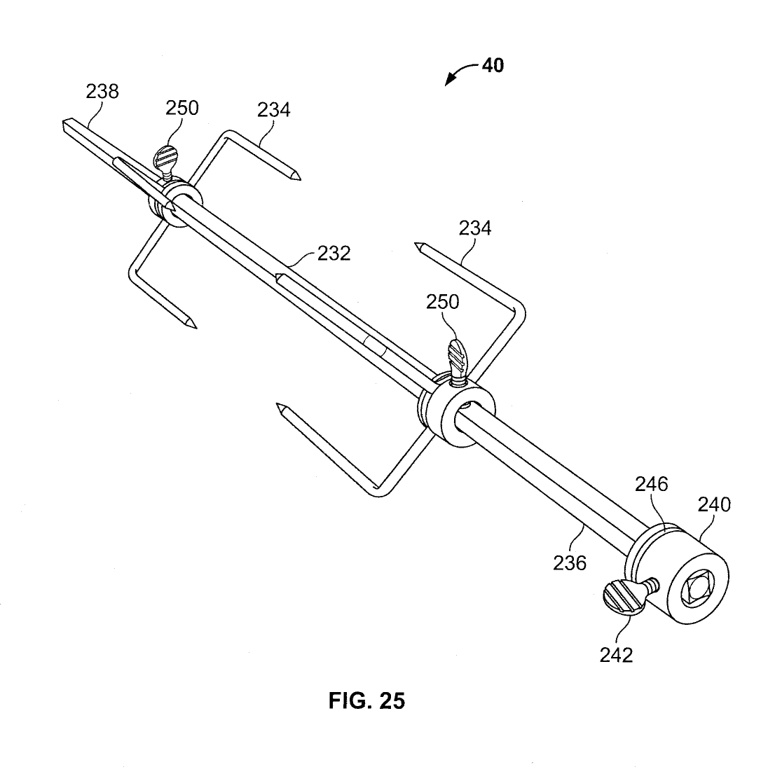

Once the front rotisserie mount 36 has been deployed into its rotisserie position, the rotisserie 40 can be mounted. As shown in FIG. 25, the rotisserie 40 defines a longitudinal axis and comprises a spit rod 232 and a pair of pronged forks 234. The spit rod 232 has a substantially square cross-sectional configuration with a bracket mounted end 236 and a motor receiving end 238. A cylindrical sleeve 240 is slidably received on the spit rod 232 and is fixed in position near the bracket mounted end 236 by a thumbscrew 242. The cylindrical sleeve 240 has a circumferential groove 246 that corresponds to a depression 248 on the remote end 196 of the center bar 188 of the front rotisserie mount 36. The pair of pronged spit forks 234 can skewer a food item (not shown) and then be slidably received onto the spit rod 232 and fixed in a desired position by thumbscrews 250.

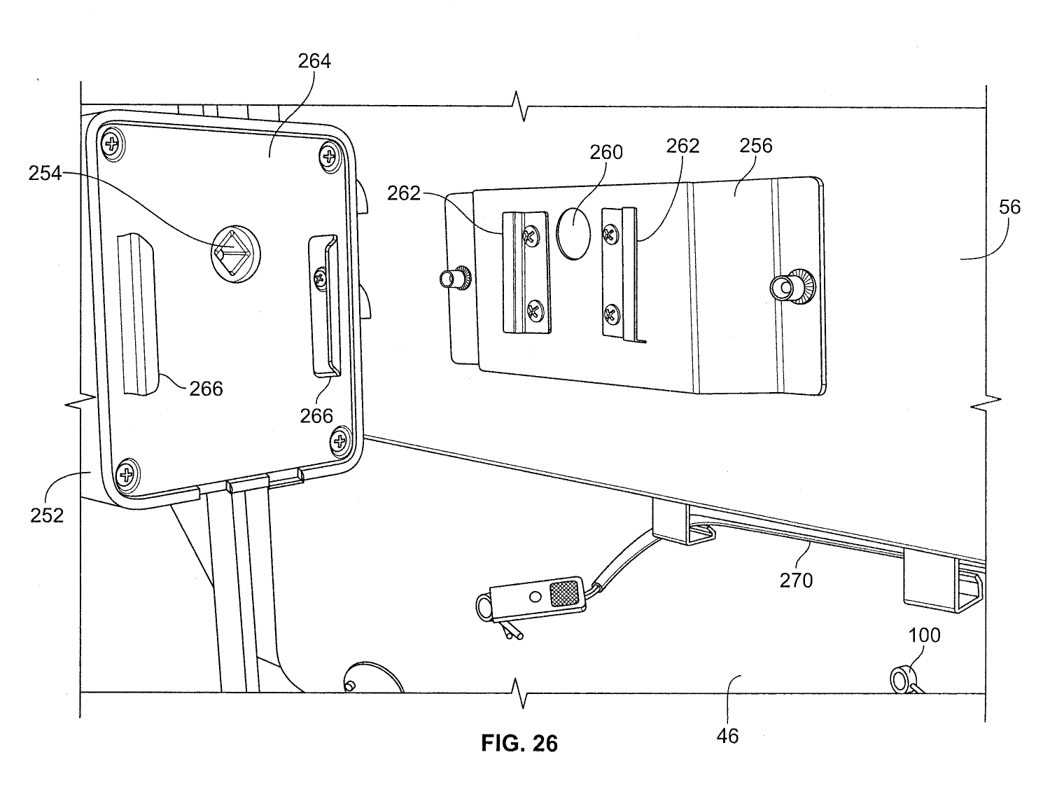

In another embodiment of the present invention, a motor 252 is the rear rotisserie mount for the rotisserie 40, as shown in FIGS. 26-27. The motor 252 revolves a female turnkey 254, which receives the motor receiving end 238 of the rotisserie spit rod 232. The female turnkey 254 has a substantially square configuration like the spit rod 232 in order to prevent the spit rod 232 from slipping as the motor receiving end 238 is revolved within the female turnkey 254.

With continued reference to FIG. 26, a motor mounting bracket 256 is fixedly attached to the outward face of upper rear wall 56 of the firebox 12 over a rear rotisserie hole 258 (FIG. 2) on the upper rear wall 56, located approximately equidistant between the right side wall 48 and the left side wall 50 of the firebox 12. The motor mounting bracket 256 has a motor mounting bracket hole 260 that is aligned with the rear rotisserie hole 258. The motor mounting bracket 256 further has a pair of bracket tabs 262 that are fixedly attached on opposites sides of the motor mounting bracket hole 260. The motor 252 has an inner surface 264 and a pair of opposing sleeves 266 that are formed from outwardly bent slits in the inner surface 264. The pair of opposing sleeves 266 are positioned on opposite sides of the female turnkey 254 for slidably accepting the pair of bracket tabs 262 of the motor mounting bracket 256 (FIG. 27).

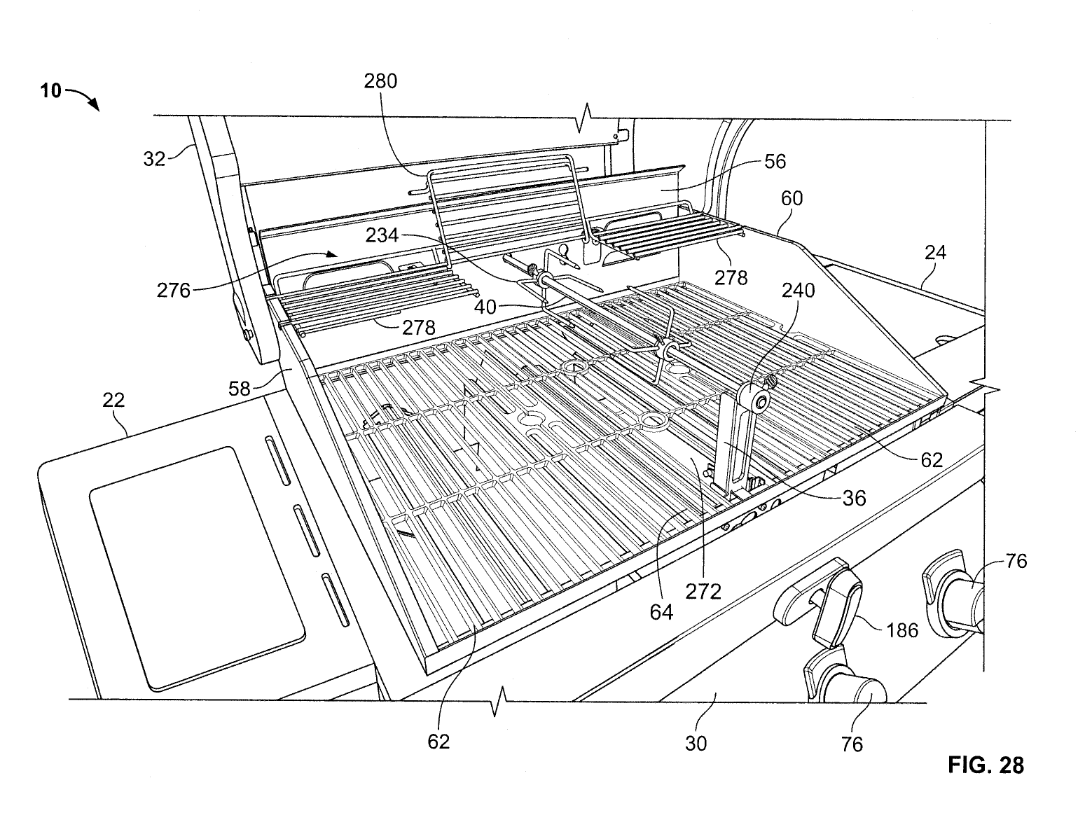

As shown in FIG. 28, the rotisserie 40 is mounted by inserting the motor receiving end 238 of the spit rod 232 through the rear rotisserie hole 258 on the firebox 12 into the female turnkey 254 on the motor 252. The circumferential groove 246 on the cylindrical sleeve 240 secured at the bracket mounted end 236 of the spit rod 232 is aligned with a depression 248 on the remote end 196 of the center bar 188 of the front rotisserie mount 36. Thus the cylindrical sleeve 240 rests on the front rotisserie mount 36 and rotates within the depression 248 as the rotisserie 40 rotates. It will be appreciated that the longitudinal axis of the rotisserie 40 extends from the front wall 44 of the firebox 12 to the rear wall 46 of the firebox 12, that is, parallel to the longitudinal axis of the middle burner tube 66, such that food skewered on the rotisserie 40 can be cooked substantially along the length of the rotisserie spit rod 232 using just the middle burner tube 66, leaving the side burner tubes 68 free for cooking other foods simultaneously while the rotisserie 40 is in use. It will be further appreciated that the first heat shields 82 are in the rotisserie position, narrowing the middle compartment 122 such that heat from the middle burner tube 66 is more focused in heat to cook the food on the rotisserie 40.

In a preferred embodiment, the motor 252 is adapted to be powered by a DC power supply in the form of one or more batteries (not shown). The electrical current from the DC power supply flows through a wire (not shown) to a motor start button 268 on the control panel 30 (FIG. 1). When the motor start button 268 is in the “on” position, the electrical current flows from the motor start button 268 to the motor 252 through a second wire 270 (FIG. 27). Alternatively, the motor 252 can be powered directly by an AC power cord (not shown).

In another embodiment, the middle cooking surface 64 includes an opening 272, as shown in FIG. 28, to provide clearance for the front rotisserie mount 36 when it is in the first position, that is, flush with the cooking surface (FIG. 5). As shown in FIG. 16, the front rotisserie mount 36 can include an elongated slot 274 that resembles the grate pattern on the cooking surfaces 62 and 64 so that the front rotisserie mount 36 can help serve as part of the middle cooking surface 64 when the front rotisserie mount 36 is in the grilling position. It will be appreciated that the front rotisserie mount 36 could be deployed into the second rotisserie position without use of the rotisserie 40, simply in order to pivot the first heat shields 82 from their first vertical position to the second inwardly pivoted position, and thus concentrate the heat from the middle burner tube 66 to the food cooking on the middle cooking surface 64.

As shown in FIGS. 3 and 28, a warming rack 276 is removably attached to the firebox 12, comprising a stationary member 278 that rests atop the upper right side wall 58 and the upper left side wall 60 of the firebox 12, and a pivoting member 280 that is pivotably attached to the stationary member 278. When the pivoting member 280 is in a first, namely grilling, position (FIG. 3), the pivoting member 280 is flush and horizontal with the stationary member 278, and when the pivoting member 280 is in a second position, namely rotisserie, position (FIG. 28), the pivoting member 280 is pivoted upward to allow the rotisserie spit rod 232 sufficient clearance while it rotates. Over-rotation of the pivoting member 280 is prevented by contact with the upper rear wall 56 of the firebox 12. When the pivoting member 280 is in the first position, substantially the entire surface area of the warming rack 276 can be used to warm food while the grill is in use. When the pivoting member 280 is in the second position, the surface area of the stationary member 278 of the warming rack 276 can still be used to warm food, even while the rotisserie spit rod 232 is in use.

The present invention has been described above in terms of presently preferred embodiments so that an understanding of the present invention can be conveyed. However, there are other embodiments not specifically described herein for which the present invention is applicable. Therefore, the present invention should not to be seen as limited to the forms shown, which are illustrative rather than restrictive. Accordingly, the invention is defined only by the following claims.

What is claimed is:

1. A grill comprising:
a firebox having a front wall, a rear wall, a left wall, and a right wall;
a plurality of burners mounted in the firebox;
a control panel positioned along the front wall of the firebox;
a plurality of burner controls for controlling the burners, the burner controls operatively positioned in the control panel;
a cooking surface positioned above the plurality of burners;
a rotisserie assembly including an elongate spit, the spit extending above at least one of the plurality of burners and in a direction substantially normal to the front and rear walls of the firebox; and
a front rotisserie mount positioned near a front edge of the cooking surface, the front rotisserie mount selectively movable between a first position in which it is retracted and does not extend substantially above the level of the cooking surface, and a second position in which it is upright and extends above the level of the cooking surface for receiving and mounting a forward end of the spit above the level of the cooking surface.

2. The grill as set forth in claim 1, wherein the at least one burner under the spit is elongate and extends longitudinally in a direction substantially parallel to the spit.

3. The grill as set forth in claim 1, wherein the spit is removably mounted in the rotisserie assembly.

4. The grill as set forth in claim 3, wherein the cooking surface has an opening sized and configured to receive the front rotisserie mount, and the front rotisserie mount is selectively movable by pivoting such that when the front rotisserie mount is in the first position it lies substantially flush with the cooking surface in the opening.

5. The grill as set forth in claim 4, wherein the cooking surface includes a grating pattern, and the front rotisserie mount is slotted to become part of the grating pattern on the cooking surface when the front rotisserie mount is in the first position.

6. The grill as set forth in claim 1, wherein the rotisserie assembly further includes a motor positioned near the rear wall of the firebox for mounting and rotating the spit.

7. A grill comprising:
a firebox having a front wall, a rear wall, a left wall, and a right wall;
a plurality of burners mounted in the firebox;
a control panel positioned along the front wall of the firebox;
a plurality of burner controls for controlling the burners, the burner controls operatively positioned in the control panel;
a cooking surface positioned above the plurality of burners;
a rotisserie assembly including an elongate, spit, the spit extending above at least one of the plurality of burners and in a direction substantially normal to the front and rear walls of the firebox; and
one or more heat dividers positioned between the at least one burner under the spit and the remaining plurality of burners, the one or more heat dividers including a generally planar panel and extending in a direction between the front and rear walls of the firebox.

8. The grill as set forth in claim 7, wherein the spit is removably mounted in the rotisserie assembly.

9. The grill as set forth in claim 8, wherein the one or more heat dividers are selectively movable between a first position in which they have a generally upright orientation relative to the cooking surface, and a second position in which the one or more heat dividers are tilted inward toward the at least one elongate burner.

10. The grill as set forth in claim 9, wherein the rotisserie assembly further includes:
a front rotisserie mount positioned near a front edge of the cooking surface, the front rotisserie mount selectively movable between a first position in which it is retracted and does not extend above the level of the cooking surface, and a second position in which it is upright and extends above the level of the cooking surface for receiving and mounting a forward end of the spit above the level of the cooking surface, and
a front rotisserie mount control operatively coupled to both the front rotisserie mount and the one or more heat dividers for selectively moving them in unison between their respective first and second positions.

11. The grill as set forth in claim 10, wherein the cooking surface has an opening sized and configured to receive the front rotisserie mount, and the front rotisserie mount is selectively movable by pivoting such that when the front rotisserie mount is in the first position it lies substantially flush with the cooking surface in the opening.

12. The grill as set forth in claim 10, further comprising a warming rack, the warming rack extending along the rear wall of the firebox, wherein at least a portion of the warming rack in the vicinity of the spit is adapted for pivoting upwards away from the spit.

13. The grill as set forth in claim 8, wherein the cooking surface comprises a plurality of removable surfaces, at least one of the removable surfaces positioned between the spit and the at least one elongate burner.

14. A grill comprising:
a firebox having a front wall, a rear wall, a left wall, and a right wall;
a plurality of burners mounted in the firebox, the plurality of burners including at least one elongate burner extending longitudinally in a direction between the front and rear walls of the firebox;
a cooking surface positioned above the plurality of burners; and
a rotisserie assembly including an elongate spit, the spit extending longitudinally in a direction between the front and rear walls, the spit positioned above and substantially parallel to the at least one elongate burner,
wherein the spit is positioned substantially solely above the at least one elongate burner.

15. The grill as set forth in claim 14, wherein the spit is removably mounted in the rotisserie assembly.

16. The grill as set forth in claim 14, wherein the rotisserie assembly further includes:
a front rotisserie mount positioned near a front edge of the cooking surface, the front rotisserie mount selectively movable between a first position in which it is retracted and does not extend substantially above the level of the cooking surface, and a second position in which it is upright and extends above the level of the cooking surface for receiving and mounting a forward end of the spit above the level of the cooking surface.

17. The grill as set forth in claim 16, wherein the cooking surface has an opening sized and configured to receive the front rotisserie mount, and the front rotisserie mount is selectively movable by pivoting such that when the front rotisserie mount is in the first position it lies substantially flush with the cooking surface in the opening.

18. The grill as set forth in claim 15, further comprising a pair of heat dividers positioned along either side of the at least one elongate burner, each heat divider including a generally planar panel extending in a direction generally parallel to the at least one elongate burner.

19. The grill as set forth in claim 18, wherein the heat dividers are selectively movable between a first position in which they have a generally upright orientation relative to the cooking surface, and a second position in which the one or more heat dividers are tilted inward toward the at least one elongate burner.

20. The grill as set forth in claim 19, wherein the rotisserie assembly further includes:
a front rotisserie mount positioned near a front edge of the cooking surface, the front rotisserie mount selectively movable between a first position in which it is retracted and does not extend above the level of the cooking surface, and a second position in which it is generally upright and extends above the level of the cooking surface for receiving and mounting a forward end of the spit above the level of the cooking surface, and
a front rotisserie mount control operatively coupled to both the front rotisserie mount and the one or more heat dividers for selectively moving them in unison between their respective first and second positions.

21. The grill as set forth in claim 15, further comprising a warming rack, the warming rack extending along the rear wall of the firebox, wherein at least a portion of the warming rack in the vicinity of the spit is adapted for pivoting upwards away from the spit.
